(19) United States
(12) Patent Application Publication
(10) Pub. No.: US 2006/0063640 A1
(43) Pub. Date: Mar. 23, 2006

(54) Transmission system

(76) Inventor: Oliver Peter Doctrove, Croydon (GB)

Correspondence Address: MANELLI DENISON & SELTER, 2000 M STREET NW SUITE 700, WASHINGTON, DC, 20036-3307, US

(21) Appl. No.: 10/940,688

(22) Filed: Sep. 15, 2004

(51) Int. Cl. B60K 41/04

(52) U.S. Cl. 477/34

(57) ABSTRACT

Step change in a motor vehicle transmission system is effected by a driver operating a single floor mounted control. The control is coupled to a control system for causing a step change in the transmission when the control is operated, the direction up or down of a particular step change being determined by automatically sensed driving conditions of the vehicle.

### BACKGROUND

This invention relates to transmission systems, and more particularly to step-wise transmission systems for motor driven vehicles.

Although transmission systems constructed in accordance with the present invention may find utility in any kind of motor driven vehicle, including boats, the invention has been devised primarily with the needs of motor land vehicles, and in particular motor cars (automobiles), in mind.

The most common form of transmission interposed between the engine and the final drive of a motor land vehicle is the conventional gear change mechanism employing a floor mounted hand operated gear lever and a gearbox, the gear lever operating mechanically to select different gears on association with a clutch mechanism usually controlled by a foot pedal. With such an arrangement, changing gear involves removing one hand from the steering wheel to operate the gear lever and at the same time using the left foot to operate the clutch while employing the right foot to operate the accelerator or the brake, as necessary. This degree of coordination between one hand and both feet, coupled with the removal of that hand from the steering wheel at least during the gear change operation, particularly in the case of a less experienced driver may result in some loss of control of the vehicle.

To case this somewhat, arrangements have been proposed in which the gear stick is relocated to the steering column or to the dashboard, but in all these arrangements, the gear stick still needs to be grasped by one hand to change gear.

In order to overcome this problem and to ensure that changes in gear take place smoothly and only when actually required by the driving conditions of the vehicle, which may not always be the case with inexperienced drivers using a fully selective change gear mechanism, automatic change gear systems have been developed over many years. In some countries, such as the United States of America, such automatic change gear systems predominate over the traditional floor-mounted gear stick and gearbox arrangement.

With an automatic transmission, however, the driver has little control over when and in which direction up or down step-wise gear changes occur, except through use of an accelerator pedal kick-down position, whereby full opening of the throttle will almost invariably result in a downward step change to the lowest viable gear. This is often utilised for overtaking manoeuvres and steep upward inclines.

Particularly in the case of experienced drivers and drivers used to driving under more extreme conditions such as, for example, really drivers and racing car drivers, such a fully automatic transmission system can be frustrating as the driver is unable to make the vehicle respond in exactly the way he wishes at a particular time under the particular conditions prevailing. As a result, manual gear change has been widely accepted as more useful performance-wise for extreme driving conditions.

However, with speed of gear change in mind, a number of electronically controlled transmission systems have been devised in which a step change in the transmission is initiated by operating switches. The conventional arrangement for such electronic change gear systems is to employ two switches controlled via the gear selection lever, which present the driver with the choice of “+” and “−” selection positions to change gear up or down by pushing or pulling the gear selection lever into the appropriate position. One such electronically controlled system employing a gear selection lever has been marketed under the Trademark Tiptronic®.

An advance on this idea has seen the introduction of two switches, in the form of buttons, mounted on the steering wheel, one button being pressed to change gear upwardly, and the other button being pressed to change gear downwardly.

The result, in either of these cases, is an almost instantaneous semi-automatic change gear system in which control has been given back to the driver both as to when, and in which direction, up or down, a step change in the transmission is to occur. The step change selected by the system, when the driver initiates a change, may not necessarily be by a single increment at a time (for example from 5^{th} gear down to 4^{th}), the step change selected by the system—given the direction selected by the driver and the time of change also selected by the driver—may be of more than a single increment (for example from 5^{th} gear straight down to 3^{rd}). Should the driver attempt to initiate a change up or down which is not viable, the system overrides the driver's request (which, in any case, is likely to have been in error in such circumstances), and no change results. These systems, and in particular the steering wheel mounted system, have enabled drivers to change gear at speed while steering round tight corners, for example in rally driving.

An attempt has also been made to provide a similar floor mounted system involving two buttons on the floor, one for changing up and the other for changing down, but otherwise working in exactly the same way as the Tiptronic® gear lever system or the alternative steering wheel mounted system. Specific examples of floor operated arrangements include GB 2325034 (Rover Group Ltd) which has separate “up” and “down” pedals, and U.S. Pat. No. 5,419,412 (schwab et al.) and DE 19754247 (Volkswagen AG), both of which disclose arrangements employing a rocker pedal with respective “Up” and “Down” positions.

Such arrangements have not proved a success as drivers found that they readily and inadvertently operated the incorrect button or the rocker in the wrong direction. The accepted view is thus that floor mounted switch-controlled electronic systems are not feasible. The gear lever and steering wheel mounted arrangements have come to be recognised as the two alternative accepted standards for switch operated electronically controlled step change transmissions.

However, I have found that, even using the steering wheel mounted arrangement, drivers tend to hesitate, particularly when cornering at speed and when their hands and the switches are no longer aligned or in the expected positions, to ensure that they do not inadvertently operate the incorrect button with potentially disastrous results. Such hesitation, with the vehicle travelling—even for a limited period only—in a less effective gear, may result in the loss of valuable seconds in competition use and may result in wear to the engine or transmission.

### SUMMARY OF THE DISCLOSURE

The present invention seeks to overcome these problems.

In accordance with a first aspect of this disclosure, there is provided a step-wise transmission system for a motor driven vehicle, comprising: a transmission of the kind adapted for step-wise change, and an automatic clutch associated therewith, a plurality of sensors adapted to sense driving conditions of said vehicle, and driver operable means for causing step-wise changes in said transmission, the driver operable means comprising: a single control adapted for mounting on a floor of the vehicle for operation by a driver's foot to initiate a step change in said transmission, and a control system coupled to the single control and adapted to cause a step change in said transmission when said single control is operated with associated operation of the automatic clutch, the direction up or down of any particular said step change being determined by prevailing conditions sensed by said sensors.

In a second and alternative aspect of this disclosure, there is provided a motor driven vehicle, comprising: a transmission of the kind adapted for step-wise change; an automatic clutch associated with the transmission; a plurality of sensors mounted to sense driving conditions of said vehicle; a single control mounted on the floor of the vehicle for operation by a driver's foot to initiate a step change in said transmission; and a control system coupled to the single control and adapted to cause a step change in said transmission when said single control is operated with associated operation of the automatic clutch, the direction up or down of any particular said step change being determined by prevailing conditions sensed by said sensors.

According to a third alternative aspect of this disclosure, a method is disclosed for step change in a motor vehicle transmission system by a driver operating a single floor mounted control, the control being coupled to a control system for causing a step change in said transmission when the control is operated, the direction up or down of a particular step change being determined by automatically sensed driving conditions of the vehicle.

Although the transmission will usually comprise a mechanical transmission involving gear wheels, whether the control is mechanical, electronic or some combination of mechanical, electronic, hydraulic and pneumatic, the invention is also applicable to other forms of transmission, and in particular to hydraulic transmission systems that employ step changes.

In the preferred arrangement described in more detail below, the control system is electronic, and may be regarded as a variation of the Tiptronic® gear lever system or of the alternative steering wheel mounted system. As with those systems, any particular step change may not necessarily consist of a single increment.

Driving conditions may be continuously sensed by the sensors so that no delay is introduced before a required step change up or down is caused to occur upon operation of the driver's foot control. The system may therefore by just as rapid as prior electronically controlled step-wise transmission systems such as the Tiptronic® system involving tow switches. However, since the driver does not have to first think which of two switches to operate, and either to move the gear selection lever or check where exactly those switches are located in relation to the current positions of his hands on the steering wheel, the change may be achieved faster overall in systems in accordance with the present invention.

The driving conditions sensed in embodiments of the step-wise transmission systems may comprise any of the driving conditions effectively sensed by conventional automatic transmission systems and/or may include sensing whether the brake is applied or sensing whether the throttle is open. Other conditions sensed may include speed of the vehicle, the driving torque, whether and to what extent the vehicle is travelling up or down an incline or whether it is travelling generally along the level, or whether and to what extent the vehicle is cornering. The sensing system is preferably entirely electronic and in systems with three or four or more conditions sensed, may employ a fuzzy logic processor to automatically determine the direction of the next indicated transmission step change so that as soon as the floor operated control is operated, a change in the indicated direction may be effected.

### BRIEF DESCRIPTION OF THE DRAWINGS

FIG. 1 schematically illustrates a motor drive arrangement;

FIG. 2 is a schematic illustration of a gear selector lever and its selectable positions in a prior electronically controlled step change transmission, showing the positions of switches;

FIG. 2A is an elevational view of a steering wheel of a vehicle employing a prior electronically controlled step change transmission, showing the positions of switches;

FIG. 3 is circuit diagram for the control system of a transmission using the arrangement of FIG. 2 or FIG. 2A;

FIG. 4 is a corresponding circuit diagram for a system employing a single foot-operated switch;

FIG. 5 is a schematic sectional view through an embodiment of floor mounted button useful as the switch in an arrangement in accordance with FIG. 4; and

FIG. 6 shows a schematic circuit diagram for the switch of FIG.5.

### DESCRIPTION OF PREFERRED EMBODIMENTS

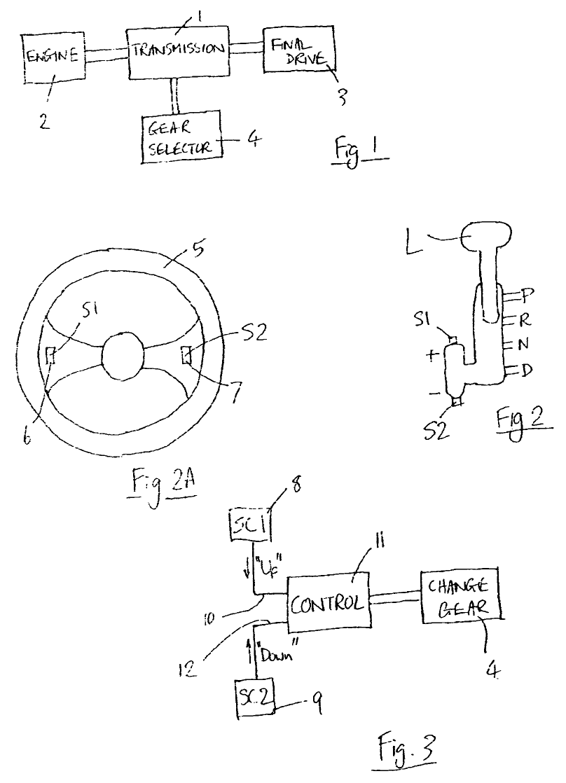

As schematically illustrated in FIG. 1, in any powered vehicle, a transmission 1 is interposed between the prime mover (engine) 2 and the final drive 3 which is coupled (not shown) to wheels (usually via an axle) or to a propeller shaft. The purpose of this is to ensure that the rate of revolution of the engine 2 may be maintained within a preferred working range as the torque and rate of revolution of the final drive 3 vary under different conditions. A change gear selector mechanism 4 is coupled to transmission 1 in order to change the gear ratio to achieve this. The basic structure of FIG. 1 will apply to virtually any driven system, whether the transmission is mechanical, primarily mechanical with electrical or electronic control, or hydraulic.

Change gear systems may take many forms as discussed in the introductory part of this specification. Specifically, an arrangement has been marketed under the Trademark Tiptronic® as schematically illustrated in FIG. 2 and 3. In the Tiptronic® arrangement, two switches S1 and S2 are positioned to be selectable via a hand-operated gear selection lever 1, which has the usual Park “P”, Reverse “R”. Neutral “N” and Drive “D” positions of an automatic transmission. In the alternative arrangement of FIGS. 2A and 3, similar switches S1 and S2, in the form of push-buttons, are mounted on a steering wheel 5 as shown at 6 and 7. In either case, the switches S1 and S2 are coupled into respective switch control circuits SC1 and SC2 shown at 8 and 9 in FIG. 3. One of the switches, here S1, is adapted to cause a step change up in the transmission when actuated while the other switch, here S2, is similarly adapted to cause a step change down.

Accordingly, in the schematic circuit illustrated in FIG. 3, closing of switch S1 will cause its corresponding switch control circuitry SC1 to send an “up” command signal along line 10 to control system 11 which is coupled to change gear mechanism 4. Similarly, if switch S2 is actuated, then the corresponding switch control circuit SC2 will send a “down” command signal along line 12 to control system 11 coupled to the change gear mechanism 4. The gear change mechanism 4 will then effect a step change, usually—though not invariable—of a single increment. Where prevailing driving conditions, given the direction and timing of the change, as selected by the driver, dictate that a double (or greater) increment would be more appropriate, that size of step change will be made. As is usual, a downward step change to the lowest viable gear can be effected by fully opening—to the kick-down position—the throttle.

As discussed in the introductory part of this specification, this arrangement, whether utilising the gear selection lever to operate switches or utilising the equivalent push-buttons mounted on the steering wheel, has proved beneficial for experienced drivers, for example, rally drivers and racing car drivers, over conventional stick mounted change gear systems or conventional fully automatic change gear systems.

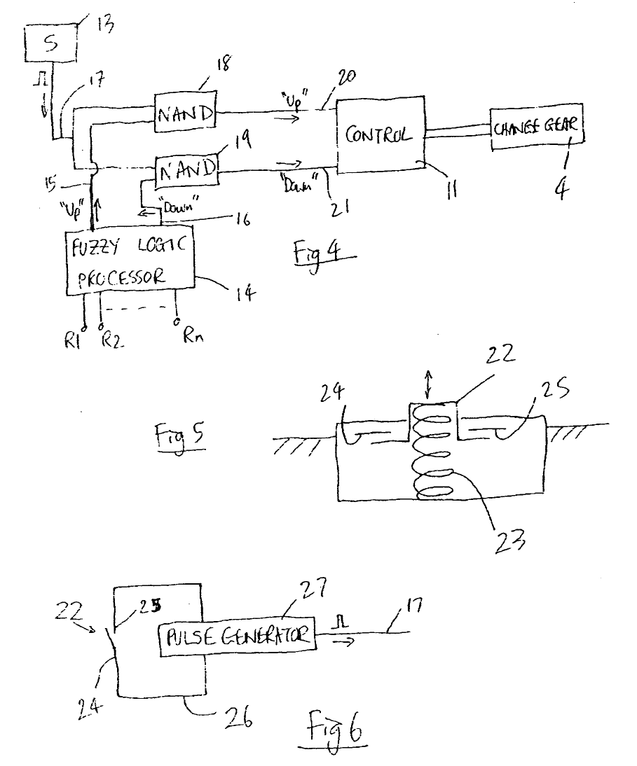

FIG. 4 schematically illustrates how the arrangement of FIGS. 2 (or 2A) and 3 may be modified in accordance with the present disclosure.

In the arrangement of FIG. 4, only a single switch S, indicated at 13 is provided. Switch S is mounted as a push-button on a floor of the vehicle, most appropriately for actuation by the left foot. A plurality of sensors R1, R2 . . . Rn adapted to sense different driving conditions are coupled to a fuzzy logic processor 14. Processor 14 operates continuously to generate either an “up” condition signal on line 15 or a “down” condition signal on line 16 depending upon the analysis by fuzzy logic processor 14 of the prevailing conditions sensed by sensors R1, R2 . . . Rn. Actuation of switch S causes a control signal 17 to e passed as respective first inputs to respective NAND gates 18 and 19 to which the respective lines 15 and 16 from fuzzy logic processor 14 are also coupled ads respective second inputs, the NAND gates only produce an output when there are inputs on both of their respective inputs. Fuzzy logic processor 14 operates continuously to analyse the inputs from sensors R1, R2 . . . Rn so that at every moment either an “up” condition signal on the line 15 or alternatively a “down” condition signal on line 16 will be produced. Thus, there will always be an input on the second input line of one or other of the two NAND gates 18 and 19. Actuation of switch S will cause an input to the first input of both NAND gates 18 and 19. The result will be that either an “up” command signal will appear on the output 20 from NAND gate 18 with no signal from NAND gate 19, or a “down” command signal will appear on the outlet 21 of NAND gate 19 with no signal from NAND gate 18, depending upon whichever of the respective second inputs 15 and 16 bears a signal at the moment that switch S is actuated. The “up” command signal on line 20 will be the exact equivalent of the “up” command signal on line 10 in the FIG. 3 arrangement while the “down” command signal on line 21 will be the exact equivalent of the “down” command signal on line 12 in the FIG. 3 arrangement so that the remainder of the system comprising control system 11 and the change gear mechanism 4 in an arrangement in accordance with the present invention may be exactly the same as for the prior art arrangement of FIGS. 2 (or 2A) and 3. Accordingly, it is not believed necessary to provide a detailed disclosure of control system 11 and change gear mechanism 4 for a man of ordinary skills to put the present invention into effect.

Sensors R1, R2 . . . Rn may take any of many various forms and may sense a variety of different driving conditions. The conditions selected may include those conditions effectively sensed in conventional automatic change gear systems.

Relevant factors may include; whether the brake is applied, whether and to what extent the throttle is open, the magnitude of the driving torque, that rate of revolution of the engine, whether and to what extent the vehicle is travelling up or down an incline or whether it is travelling generally along the level, and whether and to what extent the vehicle is cornering. Appropriate sensors for these different conditions are readily available and again it is not believed that a detailed description of individual sensors will be required for a man of skills in this art to put the invention into effect. Simple gravity or inertia switches may be sufficient to determine whether the vehicle is travelling up or down an incline or whether the vehicle is cornering. Sensing may be qualitative and/or quantitative.

Fuzzy logic processor 14 operates on the respective inputs from the respective sensors R1, R2 . . . Rn to determine overall whether the most appropriate next step change for the transmission would be up or down. Applying the brake would tend to indicate “down”; whereas opening the throttle would tend to indicate “up”. Similarly, driving torque above a particular level would tend to indicate “up” and below a different particular level would tend to indicate “down”. Again, steep inclines, whether up or down, tend to indicate “down”. Increasing speed with the vehicle travelling generally along the level would tend to indicate “up”. An increase in cornering (steering wheel turn) tends to indicate “down” and a diminishing cornering effect tends to indicate “up”.

FIG. 5 schematically illustrates a simple spring-loaded push button arrangement, which may be used with system in accordance with the present invention, in which a floor-mounted button 22 operates against the bias of a spring 23. When the button is pushed, respective plates 24 and 25 are electrically disengaged from each other, being otherwise electrically coupled via the button. The corresponding electric circuit is illustrated in FIG. 6. Normally current flows in the switch circuit 26. Operation of the press button 22 opens circuit 26 and this is effective to initiate pulse generator 27 to send a control pulse 17.

Because the control system described above with reference to FIGS. 4 to 6 is not dependent upon any particular form of transmission or any particular form of change gear mechanism, it may be employed equally well for a mechanical transmission or for an hydraulic transmission. In the case of an hydraulic transmission, other elements of the control system including the switches themselves and the NAND gates and associated lines may themselves be hydraulic rather than electronic.

Other variations will readily occur to a man of ordinary skills in this art in the light of the above description. It is my intention to cover all such modifications and variations within the scope and spirit of this invention as defined by the following claims.

1 A step-wise transmission system for a motor driven vehicle, comprising:
a transmission of the kind adapted for step-wise change, and an automatic clutch associated therewith;
a plurality of sensors adapted to sense driving conditions of said vehicle; and
driver operable means for causing step-wise changes in said transmission,
the driver operable means comprising:
a single control adapted for mounting on a floor of the vehicle for operation by a driver's foot to initiate a step change in said transmission, and
a control system coupled to the single control and to said plurality of sensors, the control system being adapted to cause a step change in said transmission when said single control is operated with associated operation of the automatic clutch, the direction up or down of any particular said step change being determined by prevailing conditions sensed by said sensors.

2. A transmission system according to claim 1, wherein said sensors are electronic in nature, and wherein any particular step change need not necessarily consist of a single increment.

3. A transmission system according to claim 1, wherein said sensors are adapted to operate continuously to sense driving conditions and to communicate sensed conditions to the control system, whereby the system is effective to cause a step change to occur substantially instantaneously upon operation of the single control by a driver's foot.

4. A transmission system according to claim 1, wherein the sensors comprise sensors adapted to sense conditions selected from: the speed of the vehicle; the rate of revolution of the engine; the driving torque; whether and to what extent the brake is applied; whether and to what extent the throttle is open; whether and to what extent the vehicle is travelling up or down an incline; and whether and to what extent the vehicle is cornering.

5. A transmission system according to claim 3, comprising at least three sensors, and wherein the control system includes a fuzzy logic processor, the sensors being adapted to provide electronic inputs to said fuzzy logic processor, and the fuzzy logic processor being adapted automatically to determine the direction of the next indicated transmission step change from the totality of said inputs.

6. A motor driven vehicle, comprising:
a transmission of the kind adapted for step-wise change;
an automatic clutch associated with the transmission;
a plurality of sensors mounted to sense driving conditions of said vehicle;
a single control mounted on the floor of the vehicle for operation by a driver's foot to indicate a step change in said transmission; and
a control system coupled to the single control and adapted to cause a step change in said transmission when said single control is operated with associated operation of the automatic clutch, the direction up or down of any particular said step change being determined by prevailing conditions sensed by said sensors.

7. A method of step change in a motor vehicle transmission system comprising the step of a driver of the vehicle operating a single floor mounted control, the control being coupled to a control system for causing a step change in said transmission when the control is operated, the direction up or down of a particular step change being determined by automatically sensed driving conditions of the vehicle.

8. A method according to claim 7, wherein the control system is electronic in nature, and wherein any particular step change need not necessarily consist of a single increment.

9. A method according to claim 8, wherein driving conditions are sensed continuously and communicated to the control system, whereby a step change occurs substantially instantaneously upon operation of the single control by a driver's foot.

10. A method according to claim 7, wherein the conditions sensed are selected from: the speed of the vehicle; the rate of revolution of the engine; the driving torque; whether and to what extent the brake is applied; whether and to what extent the throttle is open; whether and to what extent the vehicle is travelling up or down and incline; and whether and to what extent the vehicle is cornering.

11. A method according to claim 8, wherein the control system includes a fuzzy logic processor, the sensed conditions being communicated as electronic inputs to the fuzzy logic processor, and the fuzzy logic processor automatically determining the direction of the next indicated transmission step change from the totality of said inputs.
